(19) United States
(12) Patent Application Publication
(10) Pub. No.: US 2009/0198750 A1
(43) Pub. Date: Aug. 6, 2009

(54) SOUND CONTROL CALCULATOR DEVICE

(76) Inventor: Chiao-Ling LIN, Sansia Township (TW)

Correspondence Address: RABIN & Berdo, PC, 1101 14TH STREET, NW, SUITE 500, WASHINGTON, DC, 20005, US

(21) Appl. No.: 12/026,660

(22) Filed: Feb. 6, 2008

(51) Int. Cl. B43K 29/093

(52) U.S. Cl. 708/107

(57) ABSTRACT

A sound control calculator device is described. The sound control calculator device has a long case. The case at least has a sound hole, a key hole, and a window disposed at the periphery thereof and a circuit board disposed therein. The circuit board at least includes a microphone, a recording key, a voice recognition chip, and a display screen for operation thereon. The display screen is just aligned with the window at an upper cover. A password is input at the microphone, and an acoustic signal is converted into numerals by the voice recognition chip and operated, and then is displayed on the display screen.

### BACKGROUND OF THE INVENTION

1. Field of the Invention

The present invention relates to a sound control calculator and a use thereof in a pen.

2. Related Art

In daily life, many things are required to be managed by using “calculation” (for example, performing statistics on costs or counting the number of goods). If the calculation is performed by thinking, the process is quite tedious. A “calculator” is one of the most common and convenient tools for calculation. Therefore, calculators are widely used in office affairs, home financing, and shopping settlement. As shown in FIG. 5, the most well-known calculator structure mainly includes a rectangular body (60) having a numeral display screen (61) disposed at a side thereof (generally at an upper portion), and a key set (62) disposed at the rest space. When being used, numeric keys and operation symbols of the key set (62) are pressed to activate an inside operation chip to perform the data operation. Then, the results are displayed on the display screen (61) in the form of numerals. The calculator is criticized in the large volume, for example, the range of the key set (62) of the body (60) in FIG. 5, and the length (63) and width (64) occupy a considerable large position. Therefore, the calculator has the disadvantages of large volume and being inconvenient to carry.

Further, when using a common key-press calculator, the numeric keys of the key set (62) must be pressed by a finger (50) to input, thus errors are inevitable. As shown in FIG. 6, the finger (50) may press two or more numeric keys simultaneously or in a short time, thus wrong information is input. In addition to the increased errors, repeated operation also wastes time, which is the main disadvantage of the conventional calculator. The smaller the calculator is, the more frequently the disadvantage occurs, for example, for the operation function of mobile phones, or mini electronic calculator. Therefore, the calculator with reduced volume is limited by pressing keys to input data, and the situation of pressing the wrong key likely occurs, thus multiple operations must be performed to get a desired accuracy, which is another disadvantage of the conventional calculator.

In a pen calculator disclosed in U.S. Pat. No. 6,104,603, the calculator is attached on an upper part of a pen. However, errors still occur when pressing with a finger, and thus a cap must be used to press. When being used, the calculator must be moved in the axis direction, and the cap is rotated, so as to press the keys of the calculator with the end of the cap. In addition to the inconvenience of inputting numerals in the manner of x-y axis, the keys are easily be pressed by mistake. Therefore, the design is not imperfect. ROC Publication No. 354664 discloses a calculator pen structure for handwriting input. Referring to FIG. 4 of this case (not shown in the present invention), the structure includes a pen tube formed by screwing an upper tube body and a bottom tube base, a pen core disposed at the center. A bottom end of the pen core forms a penpoint, and an expanded oval ball disposed adjacent the penpoint. The oval ball is movably disposed at the bottom of the pen tube and is similar to a universal joint. The pen core has a contact pin, two buffer springs, and a digital plate disposed on the other end thereof. When the penpoint of the pen core writes, the oval ball serves as a fulcrum, such that the handwriting is magnified by the contact pin on the other end due to the lever principle and written onto the digital plate in a reversed manner, interpreted by a recognition circuit and a micro processor, and then displayed by a liquid crystal display (LCD).

The patent seems creative, but it still has the following problems in practice.

1. The pen core is a non-rigid body, when an expanded end is used as a fulcrum at a site near an end of the pen core, and the handwriting is magnified by the other end due to the lever principle, the handwriting is affected by the flexibility, the elastic deformation, and the bend under pressure of the thin and long pen core at the contact pin end. Therefore, the accuracy is doubtful.

2. The penpoint of the pen core is sharp, so it is likely to shake during writing, and the received signal of the handwriting is not clear enough due to the resonance of the two springs, together with the deformation of the pen core.

3. It requires many connection pieces for transferring the handwriting track through the shift of the bar-shaped pen core, and thus the signal is likely to be disordered

4. The digital plate is likely to be damaged when the contact pin scratches thereon.

It can be seen from the patents in prior art that the pen and the calculator are generally assembled together. However, in a general view of the existing patents, no preferred assemble design is provided, and thus the patents are not desired in practical use. The present invention is directed to a indeed novel and practical calculator capable of being applied on a pen, such that the sound control calculator and the pen are assembled into a calculator device facilitate to handwriting, convenient for reading, and accurate in calculating, and more particular, to a convenient and practicable calculator or a pen using the device by assembling a sound control electronic structure.

### SUMMARY OF THE INVENTION

The present invention is directed to a fluent and accurate sound control calculator pen. The sound control calculator pen mainly includes a long case with a circuit board disposed therein. The circuit board at least includes a microphone, a recording key, a voice recognition chip, and a display screen for operation. During using, a password can be executed at the microphone. The password is set by the recording key, and is executed through the operation of the voice recognition chip, and then numerals are displayed on the display screen as the operation result. Therefore, the process is rapid, has no errors as in the conventional key-press calculator. The calculator has a small volume, thus being accurate and convenient in use.

The present invention is further directed to a sound control calculator pen has a pen core disposed at an end of a case. The operation results of the sound control calculator mentioned above can be written by a pen end when filling in data, thus being convenient and rapid in use.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is an exploded view of a structure of the present invention;

FIG. 2 is an outside view of the structure of the present invention;

FIG. 3 is a cross-sectional structural view of the present invention;

FIG. 4 is a front structural view of the present invention;

FIG. 5 is a structural view of a conventional calculator; and

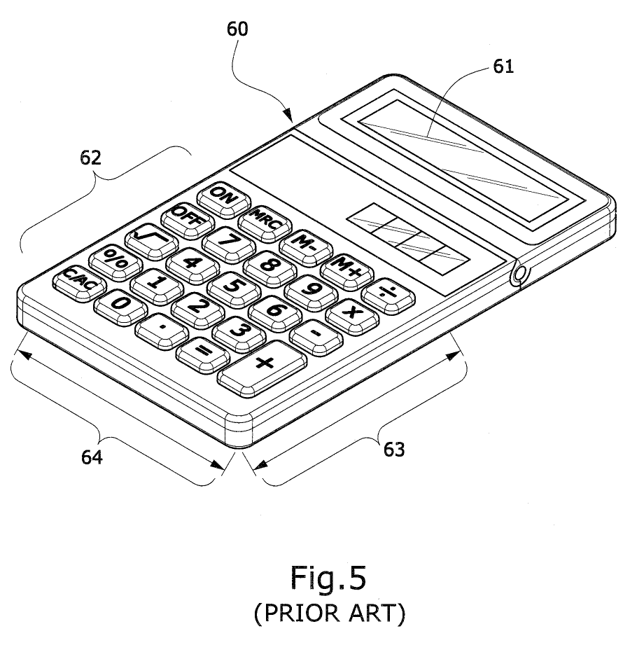

FIG. 6 is a schematic view of the use of the conventional calculator.

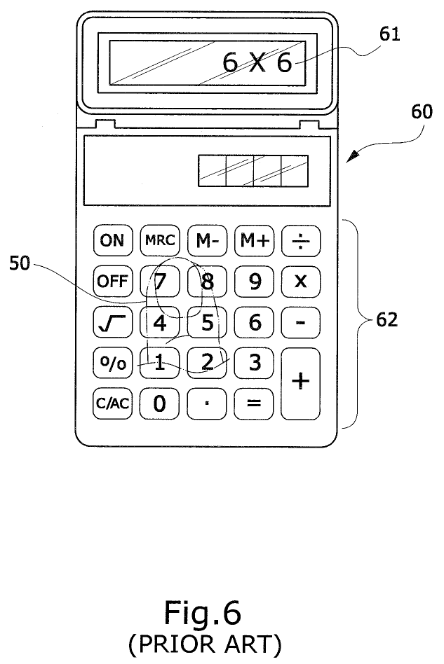

### DETAILED DESCRIPTION OF THE INVENTION

In order to make the examiners to understand the technical contents and efficacy of the present invention, preferable embodiments are described in detail with reference to the drawings hereinafter.

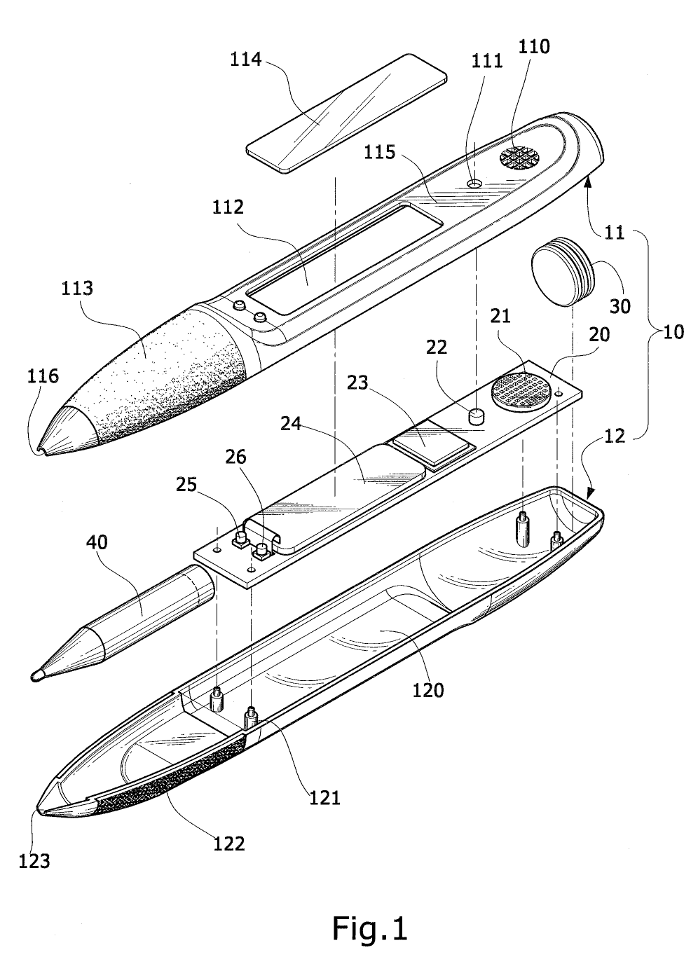

Referring to FIGS. 1, 2, 3, the present invention has a long case (10). The case (10) can be integrally formed, and can also have a bar-shaped body composed of a long upper cover (11) and a long bottom cover (12). The case (10) has a cut plane (115) disposed at a proper position of the upper cover (11). A sound hole (110), a key hole (111), and a window (112) are disposed on the cut plane (115). A window protective sheet (114) is disposed at the window (112), and the window protective sheet (114) can be designed as a magnifier for observation as desired.

The upper cover (11) can be designed to assume a converged shape at the front end to form an end portion (116) of the pen.

The case (10) has an accommodation space (120) in the bottom cover (12), and a plurality of pillars (121) disposed at the periphery thereof, for fixing the internal electric device and being latched with the upper cover (11) to form a long case (10). The bottom cover (12) can be designed to be a converged pen-shaped end portion (123). When the upper cover (11) and the bottom cover (12) fit together, a pen core (40) can be disposed at a position on the front end, so as to form a basic pen for writing, such that the present invention has the function of writing.

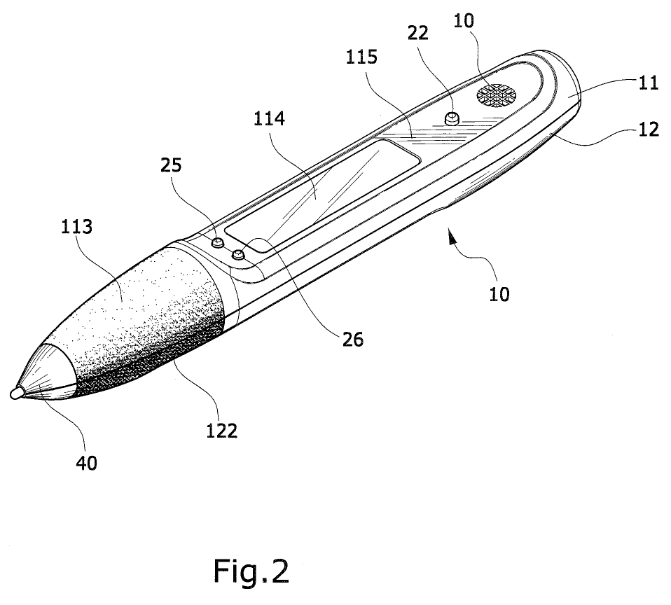

As shown in FIG. 2, the case (10) has soft grip pads (113) (122) at a proper position on the front end of the bar-shaped body, so as to facilitate the hand hold without tire.

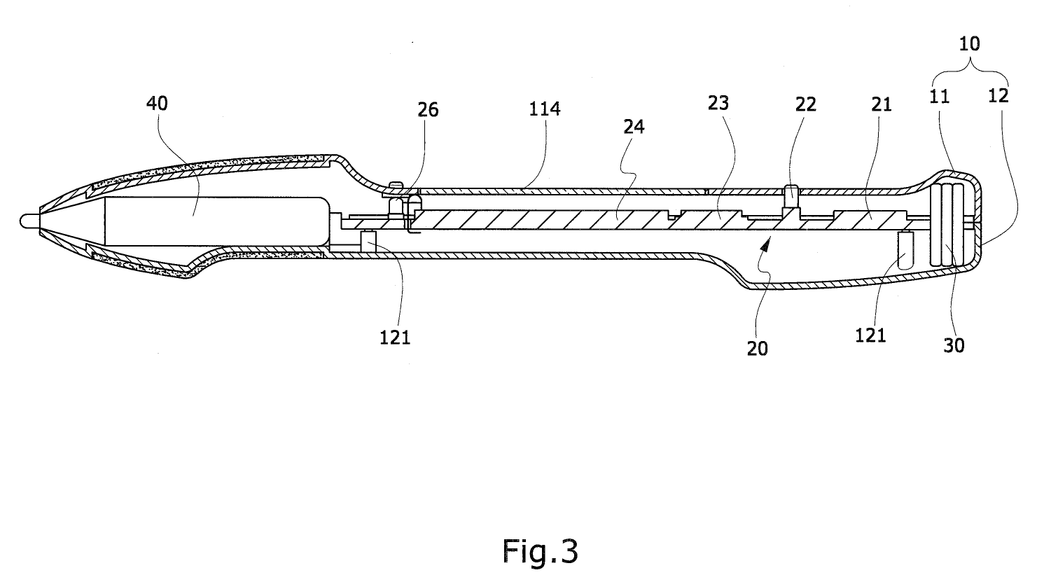

Referring to FIGS. 1 and 3, a circuit board (20) is accommodated in the accommodation space (120) of the bottom cover (12) of the case (10). The circuit board (20) at least includes a microphone (21), a recording key (22), a voice recognition chip (23), and a display screen for operation (24). The display screen (24) is just aligned with the window (114) of the upper cover (11) and covered by the window protective sheet (114). The circuit board (20) can also has a power key (25) and a function key (26) disposed thereon. The function key (26) can be designed as a multiple-functional key according to the program of the circuit board (20). The function includes left-right hand exchange key, return-to-zero key, power indicator and etc. The circuit board (20) is powered by a set of cells (30), and can also be powered by a solar cell (not shown).

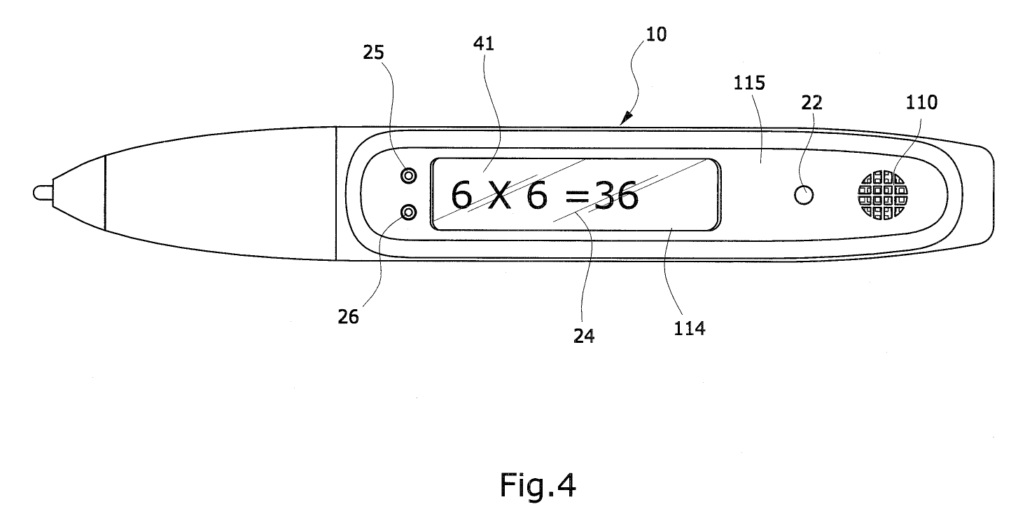

In addition to the hand writing function as shown in FIG. 2, the present invention also has the calculation function. When being used to calculate, a password can be executed at the microphone (21). The password is set by the recording key (22), and is executed through the operation of the voice recognition chip (23), and then numerals (41) are displayed on the display screen (24) as the operation result (as shown in FIG. 4). When being used to fill in data, the operation result can be written by the pen end. Therefore, the pen is convenient, rapid, and accurate in use. It is firstly pointed out that, the program and the mathematical operation of the voice recognition chip (23) are conventional programs and are not claimed in the present invention.

The present invention has the following advantages.

1. The present invention is a sound control design, and the phonetic password (it is a basic principle of common sound control) of the user is generally required to be pre-recorded, thus having a secret keeping (exclusive) effect; the electronic operation is more accurate than the conventional connecting lever transmission, and thus the “mathematic operation” is accurately and conveniently used in daily life.

2. The present invention is a long bar-shaped calculator design, particularly with a pen core, such that the pen-shaped calculator has the function of hand writing of a pen and is more time-saving and portable than a common long block-shaped calculator. When being used, the present invention can get the calculation result by performing sound control vocalization in an available space under any circumstance, and write the calculation results, and thus being more convenient than conventional calculators. Moreover, the present invention has no error of the key-press calculators, and thus being more accurate in use.

The present invention is a special and novel design, and has a simple structure and creativeness. If other function keys are simply added, the present invention will be more advantageous. The present invention is in the form of a sound control calculator, has a bar-shaped body, and has a structure of a pen, thus the integral combination has practicability, creativeness, and industrial application value. Therefore, the features of the present invention utilized merely with simple additions still fall within the scope of the content of the present invention. It is especially pointed out that, the specification and figures of the present invention are exemplification of preferred embodiments of the present invention, but not intended to limit the scope of the present invention. Equivalent structure variations of the specification and figure content of the present invention fall within the scope of the present invention.

The present invention has the advantages of convenient in use, accurate in read, and portable and has industrial application value without being published in similar structural application, and thus it meets the essential requirements for invention patent, so it is filed for patent, and we will be appreciated if it is granted with invention patent by your examiner.

What is claimed is:

1. A sound control calculator device, comprising:
a long case, at least having a sound hole, a key hole, and a window disposed at periphery thereof, and assuming a converged shape at a front end;
a circuit board, disposed in the case, and at least comprising a microphone, a recording key, a voice recognition chip, and a display screen for operation, wherein the display screen is just aligned with the window at an upper cover; and
a power key and a function key, disposed on the circuit board.

2. The sound control calculator device as claimed in claim 1, wherein the case is composed of a long upper cover and a long bottom cover.

3. The sound control calculator device as claimed in claim 2, wherein the case has an accommodation space in the bottom cover and a plurality of pillars respectively disposed at the periphery of the bottom cover.

4. The sound control calculator device as claimed in claim 1, wherein the case has a window protective sheet at the window.

5. The sound control calculator device as claimed in claim 1, wherein the case has a soft grip pad disposed at a proper position at the front part of a bar-shaped body thereof.

6. The sound control calculator device as claimed in claim 1, wherein the function key on the circuit board comprises a left-right hand exchange key, a return-to-zero key, and a power indicator.

7. The sound control calculator device as claimed in claim 4, wherein the window protective sheet is designed to be a magnifier.

8. The sound control calculator device as claimed in claim 1, wherein the circuit board is powered by a set of cells.

9. The sound control calculator device as claimed in claim 1, wherein the circuit board is powered by a solar cell.

10. The sound control calculator device as claimed in claim 1, wherein the case has a pen cored disposed at the front end thereof.

11. A sound control calculator pen, comprising:
a long case, at least comprising a sound hole, a key hole, and a window disposed at periphery thereof, and having a pan core assembled at a front end thereof to form an end portion of the pen;
a circuit board, disposed in the case, and at least comprising a microphone, a recording key, a voice recognition chip, and a display screen for operation, wherein the display screen is just aligned with the window at an upper cover; and
a power key and a function key, disposed on the circuit board.
